(19) United States
(12) Patent Application Publication
(10) Pub. No.: US 2020/0394933 A1
(43) Pub. Date: Dec. 17, 2020

(54) MASSIVE OPEN ONLINE COURSE ASSESSMENT MANAGEMENT

(71) Applicant: INTERNATIONAL BUSINESS MACHINES CORPORATION, ARMONK, NY (US)

(72) Inventors: Seema Nagar, Bangalore (IN); Sreekanth L. Kakaraparthy, Bangalore (IN); Kuntal Dey, New Delhi (IN)

(21) Appl. No.: 16/439,856

(22) Filed: Jun. 13, 2019

(51) Int. Cl. G09B 19/00; G06K 9/00

(52) U.S. Cl. CPC G09B 19/00; G09B 7/00; G06K 9/00302

(57) ABSTRACT

An embodiment of the invention may include a method, computer program product and system for transmission of data segments to a user on a computing device. An embodiment may include controlling a transmission of one or more assessment data segments to the user based on a state of perception of the user determined using sensor data for the user captured by one or more biometric sensors and further based on profile information of the user.

### BACKGROUND

Embodiments of the present invention relate generally to the fields of online education and computer-based testing, and more specifically, to personalized computer-administered assessments of an individual based on the cognitive state and perception of the individual.

In the field of online education, a massive open online course (MOOC) is an online course aimed at unlimited participation and open access via the internet. In addition to traditional course materials, such as filmed lectures, readings, and problem sets, many MOOCs provide interactive courses with user forums to support community interactions among students, professors, and teaching assistants. Many MOOCs also provide interactive computer-administered assessments of an individual's progression throughout and at the culmination of the course.

### BRIEF SUMMARY

An embodiment of the invention may include a method, computer program product and system for transmission of data segments to a user on a computing device. An embodiment may include controlling a transmission of one or more assessment data segments to the user based on a state of perception of the user determined using sensor data for the user captured by one or more biometric sensors and further based on profile information of the user.

### BRIEF DESCRIPTION OF THE DRAWINGS

FIG. 1 is a block diagram illustrating a personalized assessment system, in accordance with an embodiment of the present invention;

FIG. 2 is a flowchart illustrating the operations of the assessment engine of FIG. 1, in accordance with an embodiment of the invention;

FIG. 3 is a flowchart illustrating further operations of the assessment engine of FIG. 1, in accordance with an embodiment of the invention;

FIG. 4 is a block diagram depicting the hardware components of the personalized assessment system of FIG. 1, in accordance with an embodiment of the invention;

FIG. 5 depicts a cloud computing environment in accordance with an embodiment of the present invention; and

FIG. 6 depicts abstraction model layers in accordance with an embodiment of the present invention.

### DETAILED DESCRIPTION

Assessments are a key tool in education for measuring the learning performance and course progression of an individual, especially in online education where courses are offered through a MOOC. Typically, while watching a video lecture provided though a MOOC, there may be periodic assessment interruptions (e.g., quizzes, exams, data segments) within the lecture to assess if an individual is focused or not, and to assess whether the individual is understanding the course material or not. Currently, such assessments are usually pre-designed and pre-populated data segments. Personalization in assessments so far have focused on attempting to assess based on the capability of an individual. For example, if the individual is identified as a beginner, then the assessment will focus on basic fundamentals. As another example, if the individual did not answer a previous advanced level question correctly, then the next question of the assessment may be an intermediate level question. However, there lacks a means by which to personalize the assessments, which may include ordered periodic assessments and a final assessment, of a course beyond the afore mentioned examples. For instance, it would be advantageous to personalize the final assessment of a course based on the portions of the course where the individual struggled the most as gauged from the cognitive state of the individual at different portions of the course and the state of perception of the individual, in addition to profile information of the individual.

Moreover, these pre-designed and pre-populated periodic assessment interruptions may become distractions which make it difficult for an individual to maintain interest in the lecture. For instance, the individual may lose interest in the lecture if the assessment interruption addresses a part of the lecture which was easy for the individual to understand. Rather than serving to cement information gleaned from the lecture, such an assessment interruption may in fact be detrimental to the flow of the lecture and the maintained interest of the individual. As such, it would be advantageous to implement a mechanism by which the individual can skip potentially distracting and unnecessary assessment interruptions (i.e., data segments) based on the cognitive state of the individual and the state of perception of the individual, in addition to profile information of the individual.

In an effort to meet the needs stated above, embodiments of the present invention may include a Personalized Assessment System (PAS) 100, described below, which presents a method for controlling the transmission of one or more assessment data segments to an individual, engaged in a computer-administered course (e.g., a MOOC), based on the known cognitive state of the individual and evolution of the state of perception (i.e., one or more perception states) of the individual while progressing through the course, in addition to profile information of the individual, if available. Controlling the transmission may include skipping at least one of the one or more assessment data segments based on the perception state of the user. Controlling the transmission may also include selecting at least one assessment data segment of the one or more assessment data segments, from a database, for transmission to the user, based on the perception state of the user and transmitting the at least one assessment data segment to the user on the computing device. In embodiments of the invention, PAS 100 may include a perception-cognition-background engine (PCBE) which may determine the cognition and perception of an individual engaged in a computer-implemented course (e.g., a video lecture provided through a MOOC), as well as determine background information of the individual, if available. Based on the determined cognition, perception, and any background information of the individual, PAS 100 may, in embodiments of the invention, provide personalized course related computer-implemented assessment data segments (e.g., quiz, exam), both periodic and final, which are personalized for the individual.

Embodiments of the present invention will now be described in detail with reference to the accompanying Figures.

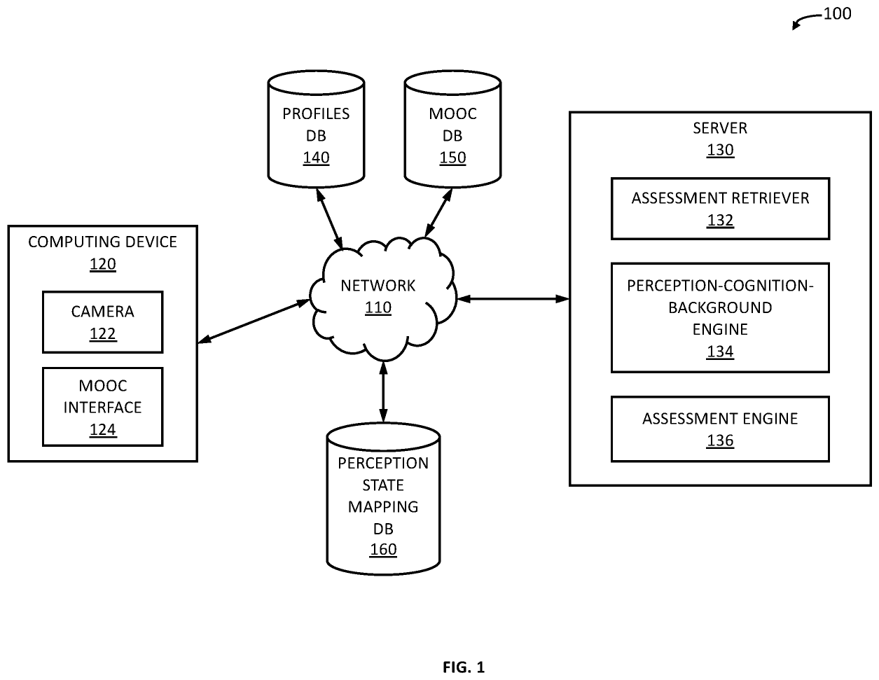

FIG. 1 is a functional block diagram illustrating Personalized Assessment System 100, in accordance with an embodiment of the present invention. In an example embodiment, PAS 100 may include computing device 120, profiles database 140, MOOC database 150, perception state mapping database 160, and server 130, all interconnected via network 110.

In embodiments of the invention, personalized course related computer-implemented assessments provided by PAS 100 may include, for example, skipping one or more pre-designed ordered assessment data segment interruptions in a course (e.g., a lecture video) which were deemed too simple as judged from available profile data of the individual, the cognitive state of the individual, and the perception of the individual when he/she was watching that portion of the course for which the assessment interruption is meant to assess. In embodiments of the invention, personalized course related computer-implemented assessments provided by PAS 100 may further include generating a personalized final assessment data segment at the end of the course based on which portions of the course were more difficult for the individual as judged from available profile data of the individual and evolution of both the cognitive state and perception state of the individual while progressing through the entire course. In other embodiments of the invention, PAS 100 may also dynamically generate one or more personalized assessment data segments at given points during the course, prior to the end of the course, based on portions of the course which were more difficult for the individual as judged from available profile data of the individual, the cognitive state of the individual, and the perception of the individual when he/she was watching that portion of the course. In yet other embodiments of the invention, PAS 100 may reorder at least one remaining assessment data segment, of the ordered assessment data segment, based on available profile data of the individual, the cognitive state of the individual, and the perception of the individual when he/she was watching that portion of the course for which the at least one remaining assessment segment is meant to assess. In various embodiments PAS 100 may transmit one or more assessment data segments, both pre-designed ordered assessment data segments and dynamically generated assessment data segments, to a computing device of the user for display to the user.

In embodiments of the invention, PAS 100 may undergo an initialization process (i.e., a bootstrapping method) whereby PAS 100 accepts and/or retrieves inputs such as, but not limited to, various MOOC content data (e.g., video data segments, audio data segments, graphics, text), any pre-designed and pre-populated assessment data segments of the MOOC, a mapping which identifies which portions of the MOOC the pre-designed and pre-populated assessment data segments are meant to test, and any available profile data of an individual participating in the MOOC. If profile data of the individual participating in the MOOC is not available, PAS 100 may assume a default level of the individual for which the MOOC is meant to teach. During the initialization process, PAS 100 may also create a basic learner model for the individual participating in the MOOC. In an example embodiment, the initialization process and functionality of PAS 100 may automatically commence in response to the individual beginning participation in the MOOC on a computing device (e.g., computing device 120). In another embodiment, the initialization process and functionality of PAS 100 may commence in response to the individual enabling PAS 100 via a button (not shown) in MOOC interface 124.

In various embodiments, network 110 is a communication channel capable of transferring data between connected devices. In an example embodiment, network 110 may be the Internet, representing a worldwide collection of networks and gateways to support communications between devices connected to the Internet. Moreover, network 110 may include, for example, wired, wireless, or fiber optic connections which may be implemented as an intranet network, a local area network (LAN), a wide area network (WAN), or any combination thereof. In further embodiments, network 110 may be a Bluetooth network, a WiFi network, or a combination thereof. In general, network 110 can be any combination of connections and protocols that will support communications between computing device 120, profiles database 140, MOOC database 150, perception state mapping database 160, and server 130.

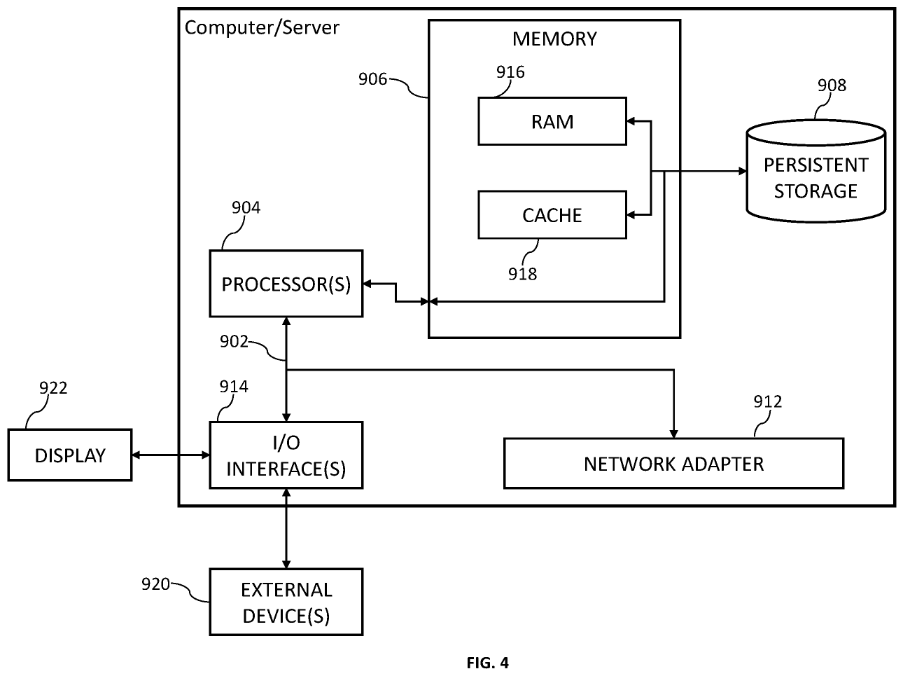

In an example embodiment, computing device 120 may include camera 122 and MOOC interface 124. Computing device 120 may be a laptop computer, a notebook, a tablet computer, a netbook computer, a personal computer (PC), a desktop computer, a personal digital assistant (PDA), a smart phone, a wearable computing device, a smart tv, or any other electronic device or computing system capable of sending, and receiving data to and from other computing devices such as profiles database 140, MOOC database 150, perception state mapping database 160, and server 130, via network 110, and capable of supporting the functionality required of embodiments of the invention. For example, computing device 120 may support a communication link (e.g., wired, wireless, direct, via a LAN, via the network 110, etc.) between computing device 120, profiles database 140, MOOC database 150, perception state mapping database 160, and server 130. Data sent from computing device 120 may include data from camera 122 and MOOC interface 124. Data received by computing device 120 may include data/instructions sent, via server 130 and network 110, from MOOC database 150 and assessment engine 136, both described below. Computing device 120 may be described, generally, with respect to FIG. 4 below. In an example embodiment, computing device 120 (e.g., the user's laptop) may send data captured by camera 122 and MOOC interface 124 to server 130, via network 110.

In an example embodiment, camera 122 may be housed within computing device 120 and configured to provide, to MOOC interface 124, sensor data. The sensor data may include biometric data such as digital information corresponding to captured images of a user (e.g., still images and/or video). For example, camera 122 may be configured to capture biometric data including one or more facial expressions of an individual participating in an MOOC through the use of computing device 120. It should be understood that various types of cameras, including night vision enabled cameras, infrared sensing cameras, etc., are within the scope of the present invention. In various embodiments, the digital information can correspond to, for example, a video stream, a series of images captured at regular intervals, or images captured and transmitted as the result of a triggering event occurring on computing device 120, such as initialization of MOOC interface 124. In various embodiments, camera 122 may be one of multiple biometric sensors configured to provide biometric sensor data to MOOC interface 124. In an example embodiment, camera 122 provides digital information corresponding to captured images (e.g., facial expressions) of an individual participating in a MOOC to MOOC interface 124.

In an example embodiment, MOOC interface 124 may be a program, or subroutine contained in a program, that may allow a user of computing device 120 to interact with a MOOC module (not shown) hosted on server 130, via network 110. For example, an individual participating in a MOOC hosted on server 130 may watch and/or listen to lectures and execute assessments of the MOOC via MOOC interface 124. In addition, MOOC interface 124 may be connectively coupled to hardware components, such as those depicted by Figure [ ], for receiving user input, including mice, keyboards, touchscreens, microphones, cameras, and the like. For example, MOOC interface 124 may receive digital information from camera 122 for transmission to server 130. In an example embodiment, MOOC interface 124 is implemented via a web browsing application containing a graphical user interface (GUI) and display that is capable of transferring data files, folders, audio, video, hyperlinks, compressed data, and other forms of data transfer individually or in bulk. In other embodiments, MOOC interface 124 may be implemented via other integrated or standalone software applications and hardware capable of receiving user interaction and communicating with other electronic devices. In an example embodiment, MOOC interface 124 may send and receive data to and from assessment retriever 132, perception-cognition-background engine 134, and assessment engine 136, via network 110. In addition, MOOC interface 124 may display various types of MOOC activities to be performed by a user of computing device 120. In an example embodiment, MOOC interface 124 may display/present MOOC lecture material and one or more personalized assessment data segments at given points during the MOOC to an individual participating in a MOOC (not shown) hosted on server 130. Furthermore, in an example embodiment, MOOC interface 124 may send digital information captured by camera 122 and responses to the one or more personalized assessment data segments to server 130, via network 110.

In an example embodiment, profiles database 140 may be a laptop computer, tablet computer, netbook computer, personal computer (PC), desktop computer, a networked computer appliance, or any other networked programmable electronic device capable of storing data and capable of an exchange of data with other electronic devices (e.g., computing device 120 and server 130), for example, through a network adapter, in accordance with an embodiment of the invention. In embodiments of the present invention, profiles database 140 may store profile data of one or more individuals participating in a MOOC. Profile data of an individual may include, but is not limited to, information pertaining to prior courses taken by the individual (e.g., topic and assessment score(s)), education level of the individual, areas of study of the individual, and learning performance of the individual in the current MOOC (e.g., responses to assessments taken by the individual thus far in the current MOOC). In embodiments of the present invention, the data stored within profiles database 140 may be populated during an initialization process of PAS 100. In embodiments of the present invention, profile data of an individual within profiles database 140 may be updated as a result of the individual's participation (i.e., lectures watched and/or listened to, assessments taken) in a MOOC. In embodiments of the present invention, the data stored in profiles database 140 may be structured (i.e. have associated metadata), partially structured, or unstructured. Moreover, the data within profiles database 140 may be written in programming languages of common file formats such as .docx, .doc, .pdf, .rtf, .mp3, .wma, .m4p, .wav, .jpg, .tif, .gif, .bmp, etc. In an example embodiment, profiles database 140 may contain profile information of an individual participating in a MOOC hosted by sever 130. The profile data of the individual may be retrieved by perception-cognition-background engine 134, via server 130 and network 110. Profiles database 140 may be described generally with respect to FIG. 4 below. In another embodiment, profiles database 140 may be located in server 130.

In an example embodiment, MOOC database 150 may be a laptop computer, tablet computer, netbook computer, personal computer (PC), desktop computer, a networked computer appliance, or any other networked programmable electronic device capable of storing data and capable of an exchange of data with other electronic devices (e.g., computing device 120 and server 130), for example, through a network adapter, in accordance with an embodiment of the invention. In embodiments of the present invention, MOOC database 150 may store digital content of a MOOC. Digital content of a MOOC may include, but is not limited to, audio and/or visual lectures of the MOOC, ordered assessment data segments (e.g., quizzes, exams) of the MOOC, and performance results (i.e., assessment scores) of one or more individuals for each assessment taken by the one or more individuals. MOOC database 150 may also store the timing/scheduling of the digital content of the MOOC. Each assessment data segment of the MOOC may be labeled with the portion of the MOOC it is meant to assess. In embodiments of the present invention, the data stored within MOOC database 150 may be populated during an initialization process of PAS 100. In embodiments of the present invention, digital content of the MOOC within MOOC database 150 may be updated as a result of the individual's participation (i.e., lectures watched and/or listened to, assessments taken) in the MOOC. In embodiments of the present invention, the data stored in MOOC database 150 may be structured (i.e. have associated metadata), partially structured, or unstructured. Moreover, the data within MOOC database 150 may be written in programming languages of common file formats such as .docx, .doc, .pdf, .rtf, .mp3, .wma, .m4p, .wav, .jpg, .tif, .gif, .bmp, etc. In an example embodiment, MOOC database 150 may contain digital content (e.g., lectures and assessments) of a MOOC hosted by sever 130. In an example embodiment, the digital content of the MOOC may be retrieved by assessment retriever 132 for transmission to computing device 120, via server 130 and network 110. Data within MOOC database 150 may also be accessible by perception-cognition-background engine 134 and assessment engine 136, via server 130 and network 110. MOOC database 150 may be described generally with respect to FIG. 4 below. In another embodiment, MOOC database 150 may be located in server 130.

In an example embodiment, perception state mapping database 160 may be a laptop computer, tablet computer, netbook computer, personal computer (PC), desktop computer, a networked computer appliance, or any other networked programmable electronic device capable of storing data and capable of an exchange of data with other electronic devices (e.g., computing device 120 and server 130), for example, through a network adapter, in accordance with an embodiment of the invention. In embodiments of the present invention, perception state mapping database 160 may store one or more perception states, as determined by PCBE 134 described below, of one or more individuals participating in a MOOC over a period of time. The one or more perception states of the individual over time amount to an evolution of perception states of the individual as he/she progresses through the MOOC. Furthermore, recording/storing the evolution of perception states of the individual creates and maintains a mapping of the individual's perception state to different portions (e.g., lecture segments) of the MOOC. For example, an individual may possess a different perception state for different slides of a MOOC lecture. Perceptual states determined by PCBE 134, described below, and stored within perception state mapping database 160 may include, but are not limited to: neutral and focused; on task and engaged concentration; confused and concentrated on task; confused and off task; bored and attentive on task; bored and on task; and frustrated. Additionally, perceptual states stored within perception state mapping database 160 which were identified, by PCBE 134, as being more difficult for the individual may be flagged. In embodiments of the present invention, the data stored within perception state mapping database 160 may be populated during an individual's participation (i.e., watching and/or listening to lectures, taking assessments) in the MOOC. In embodiments of the present invention, the data stored in perception state mapping database 160 may be structured (i.e. have associated metadata), partially structured, or unstructured. Moreover, the data within perception state mapping database 160 may be written in programming languages of common file formats such as .docx, .doc, .pdf, .rtf, .mp3, .wma, .m4p, .wav, .jpg, .tif, .gif, .bmp, etc. In an example embodiment, perception state mapping database 160 may contain one or more perception states of an individual, as determined by PCBE engine 134 (described below), participating in a MOOC, hosted by sever 130, which correspond to different portions of the MOOC. In an example embodiment, the data stored within perception state mapping database 160 may be accessed, retrieved, and/or updated by perception-cognition-background engine 134, via server 130 and network 110. Perception state mapping database 160 may be described generally with respect to FIG. 4 below. In another embodiment, perception state mapping database 160 may be located in server 130.

In an example embodiment, server 130 may include assessment retriever 132, perception-cognition-background engine 134, and assessment engine 136. Server 130 may be a desktop computer, a notebook, a laptop computer, a blade server, a networked computer appliance, a virtual device, or any other networked electronic device or computing system capable of receiving and sending data from and to other computing devices such as computing device 120, profiles database 140, MOOC database 150, and perception state mapping database 160, via network 110, and capable of supporting the functionality required of embodiments of the invention. In an example embodiment, server 130 may function to process data received from computing device 120, profiles database 140, MOOC database 150, and perception state mapping database 160, via network 110. While server 130 is shown as a single device, in other embodiments, server 130 may be comprised of a cluster or plurality of computing devices, working together or working separately. Server 130 may be described generally with respect to FIG. 4 below.

In an example embodiment, assessment retriever 132 may be a program, or subroutine contained in a program, that may operate to retrieve digital content of a MOOC from MOOC database 150 for transmission to computing device 120, via server 130 and network 110. Retrieved digital content of a MOOC may include, but is not limited to, audio and/or visual lectures of the MOOC and assessment data segments (e.g., quizzes, exams) of the MOOC. In embodiments of the present invention, assessment data segments of the MOOC may be pre-designed, pre-populated, and have fixed timing within a lecture of the MOOC. Assessment retriever 132 may record the timing/scheduling of any pre-designed and pre-populated assessment data segments and create one or more mappings which identify which portion(s) of the MOOC course (e.g., audio file, video file, presentation) the assessment data segment(s) is/are meant to assess. In embodiments of the present invention, assessment retriever 132 may transmit any retrieved data and any created mappings to perception-cognition-background engine 134 and/or assessment engine 136.

In an example embodiment, perception-cognition-background engine (PCBE) 134 may be a program, or subroutine contained in a program, that may operate to determine one or more states of perception and levels of cognition of one or more individuals participating in a MOOC. The one or more states of perception and levels of cognition, as determined by PCBE 134, may correspond to one or more portions of the MOOC. In an example embodiment, PCBE 134 may make these determinations in response to receiving data from assessment retriever 132 indicating an approaching assessment of the MOOC. PCBE 134 may also begin making these determinations when an individual starts the MOOC and continue to make these determinations at various points over a period of time during which the one or more individuals are participating in the MOOC. As mentioned above, one or more perception states of an individual over time amount to an evolution of perception states of the individual as he/she progresses through the MOOC. An evolution of the individual's state of perception, as determined by PCBE 134, may be based in part on profile information of the individual, if available, and metrics of the individual, observed over the duration of the MOOC, such as, but not limited to, facial expressions, emotions, and eye gaze behavior. In embodiments, information relating to the afore mentioned observed metrics (e.g., facial expressions, emotions, and eye gaze behavior) may be gathered, in part, by camera 122 and sent to PCBE 134 via MOOC interface 124 and network 110. Through determining one or more perception states of the individual throughout the duration of the MOOC, it may be feasible to identify portions of the MOOC which were easier or more difficult for the individual. In an example embodiment, PCBE 134 may store determined perception states of the individual within perception state mapping database so that a mapping of perception states corresponding to different portions of the MOOC may be maintained. In an example embodiment, PCBE 134 may flag determined perception states of the individual which were identified as being more difficult for the individual. The cognitive sate of the individual, as determined by PCBE 134, may be based in part on the determined one or more perception states of the individual in combination with cognition factors such as, but not limited to, prior knowledge of the individual (e.g., individual profile data) and prior demonstration of understanding of related material (e.g., answers to earlier assessments in the course).

In an example embodiment, the determination of a perception state of the individual may cause PCBE 134 to execute a cognition retrieval process and a background retrieval process. In an example embodiment, PCBE 134 may access data stored in profiles database 140, MOOC database 150, and perception state mapping database 160. The cognition retrieval process, as performed by PCBE 134, may retrieve the learning performance thus far of the individual in the current MOOC (i.e., scores for assessments taken thus far in the current MOOC), and compute a cognition score based on the score(s) the individual obtained in their prior assessment(s) and the alignment of the questions and material covered in the prior assessment(s) with an upcoming assessment. In an example embodiment, the computed cognition score may be sent to or retrieved by assessment engine 136. The background retrieval process, as performed by PCBE 134, may check for any prior knowledge of a topic of the MOOC based on profile information (e.g., prior courses taken in past sessions and elsewhere which are known to PAS 100) stored in profiles database 140, and compute a background match score based on an alignment of such prior courses with the current MOOC material. In an example embodiment, the computed background match score may be sent to or retrieved by assessment engine 136.

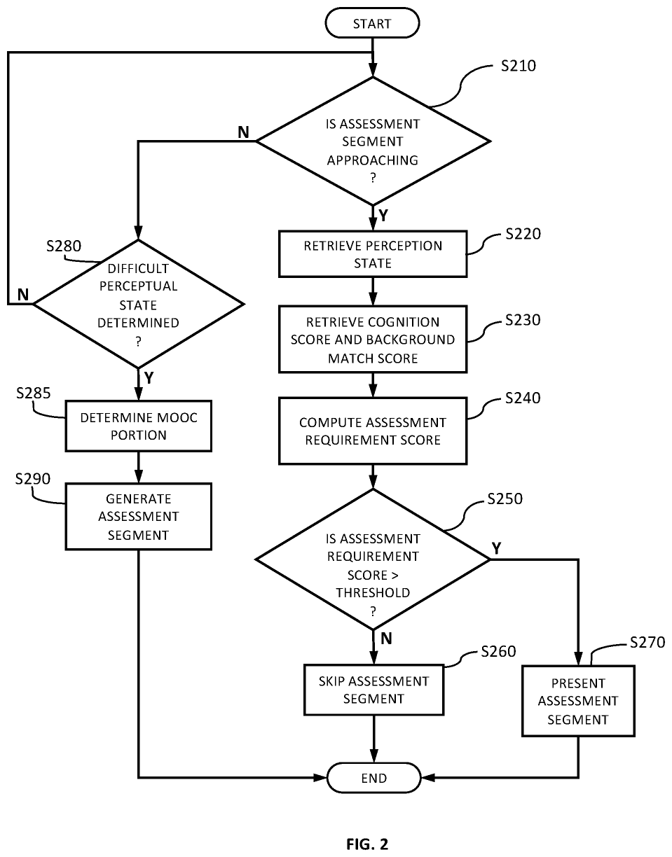

In an example embodiment, assessment engine 136 may be a program, or subroutine contained in a program, that may operate to skip one or more pre-designed ordered assessment data segments (e.g., a quiz, an exam) in a MOOC which were deemed too simple as determined from available profile data of the individual, the cognitive state of the individual, and the perception of the individual when he/she was watching that portion of the MOOC for which the assessment data segment is meant to assess. In an example embodiment, assessment engine 136 may also operate to generate a personalized final assessment data segment at the end of the MOOC based on which portions of the MOOC were more difficult for the individual as determined from available profile data of the individual and evolution of both the cognitive state and perception state of the individual while progressing through the entire MOOC. Assessment engine 136 may transmit the personalized final assessment data segment to computing device 120 for presentation to the user via MOOC interface 124. Additionally, assessment engine 136 may operate to dynamically generate one or more personalized assessment data segments at given points during the MOOC based on portions of the course which were more difficult for the individual as determined from available profile data of the individual, the cognitive state of the individual, and the perception of the individual when he/she was watching that portion of the MOOC. As part of its operation, assessment engine 136 may, in an example embodiment, access data stored within profiles database 140, MOOC database 150, and perception state mapping database 160, via server 130 and network 110. For example, in dynamically generating the one or more personalized assessment data segments at given points during the MOOC, assessment engine 136 may utilize and reorder one or more portions (e.g., questions) of any existing assessment data segments of the MOOC stored within MOOC database 150. Assessment engine 136 may transmit the one or more personalized assessment data segments at given points during the MOOC to computing device 120 for presentation to the user via MOOC interface 124. In an example embodiment, assessment engine 136 may also receive data from assessment retriever 132 and PCBE 134. The operations and functions of assessment engine 136 are described in further detail below with regard to FIG. 2. In another embodiment, the operation and functionality of PCBE 134 may be performed by assessment engine 136.

In embodiments of the invention, assessment engine 136 may perform the action of controlling a transmission of one or more assessment data segments to the user based on a perception state of the user determined using sensor data of the user captured by one or more biometric sensors and further based on profile information of the user. Controlling the transmission may include skipping at least one of the one or more assessment data segments based on the perception state of the user. Controlling the transmission may also include selecting at least one assessment data segment of the one or more assessment data segments, from a database, for transmission to the user, based on the perception state of the user and transmitting the at least one assessment data segment to the user on the computing device.

FIG. 2 shows a flowchart illustrating the operations of assessment engine 136 in accordance with an example embodiment of the invention. Referring to step S210, device assessment engine 136 may determine if an assessment data segment of the MOOC is imminent. In an example embodiment, assessment engine may make this determination by accessing data captured by assessment retriever 132 such as the timing/scheduling of any pre-designed and pre-populated assessment data segments of the MOOC. In another embodiment, assessment engine 136 may, at step S210 receive a notification of an imminent assessment data segment from assessment retriever 132. In yet another embodiment, assessment engine 136 may make this determination by accessing data stored in MOOC database 150, via network 110 and server 130. If it is determined that an assessment data segment of the MOOC is approaching, assessment engine 136 may proceed to step S220. In an example embodiment, assessment engine 136 access the timing/scheduling of pre-designed assessment data segments of the MOOC captured by assessment retriever 132 and determines that an assessment data segment of the MOOC is scheduled to be presented to the individual participating in the MOOC via computing device 120.

Referring to step S220, in response to determining that an assessment data segment of the MOOC is approaching, assessment engine 136 may retrieve the perception state, as determined by PCBE engine 134, of the individual for the portion of the MOOC the approaching assessment data segment is meant to assess. In an example embodiment, assessment engine 136 may retrieve the perception state from PCBE engine 134 and/or perception state mapping database 160. As mentioned above, PCBE 134 may begin determining perception states of the individual in response to receiving data from assessment retriever 132 indicating an approaching assessment of the MOOC. PCBE 134 may also begin determining perception states of the individual when the individual starts the MOOC and continue to determine perception states at various points over the period of time during which the individual is participating in the MOOC. Also as mentioned above, determined perception states of an individual over time amount to an evolution of the individual's perception states, which correspond to different portions of the MOOC, as he/she progresses through the MOOC. In an example embodiment, the retrieved perception state of the individual for the portion of the MOOC the approaching assessment data segment is meant to assess may indicate that the individual was bored and on task for that portion of the MOOC.

Referring to step S230, assessment engine 136 may retrieve the cognition score and the background match score, as determined by PCBE engine 134 (described above), of the individual. Assessment engine 136 may retrieve the cognition score and the background match score from PCBE engine 134. In an example embodiment, assessment engine 136 may receive a cognition score and a background match score which indicates that the individual is familiar with the portion of the MOOC the approaching assessment data segment is meant to assess.

Referring to step S240, assessment engine 136 may compute an assessment requirement score based on the retrieved perception state of the individual for the portion of the MOOC the approaching assessment data segment is meant to assess, the retrieved cognition score, and the retrieved background match score. For example, the computed assessment requirement score may be the result of combining the retrieved perception state, cognition score, and background match score. In an embodiment of the invention, the retrieved perception state, cognition score, and background match score may be weighed equally. In an embodiment of the invention, the retrieved perception state, cognition score, and background match score may be weighed differently.

Referring to step S250, assessment engine 136 may determine whether or not the computed assessment requirement score is greater than a threshold value. A Boolean decision may be made, comparing the assessment requirement score with the threshold value, on whether an approaching assessment data segment of the MOOC is to be presented to the individual or not. In embodiments of the invention, assessment engine 136 may combine the individual's state of perception, at any point during its evolution, with available cognition factors (e.g., cognition score and background match score) for the individual in order to control the transmission of a particular assessment data segment, for instance, to determine whether a particular assessment data segment should be transmitted and presented to the user or skipped (i.e., not transmitted and not presented). In embodiments of the invention, assessment engine 136 may flag assessment data segments of the MOOC which were skipped. In an example embodiment where assessment engine 136 determines that the computed assessment requirement score is not greater than the threshold value, assessment engine 136 may proceed to step S260 where the approaching data segment of the MOOC is not presented to the individual and is marked, within MOOC database 150, as being skipped. Furthermore, assessment engine 136 may transmit, to MOOC interface 124, the Boolean decision not to present the approaching assessment data segment of the MOOC to the individual. In an embodiment where assessment engine 136 determines that the computed assessment requirement score is greater than the threshold value, assessment engine 136 may proceed to step S270 where the approaching data segment of the MOOC is presented to the individual, via MOOC interface 124 of computing device 120.

In an alternate embodiment of the invention, assessment engine 136 may proceed to step S280 in response to determining that an assessment data segment of the MOOC is not imminent. At step S280 assessment engine 136 may access PCBE 134 to determine if a perception state of the individual was flagged by PCBE 134 as being more difficult for the individual. In yet another alternate embodiment, assessment engine 136 may receive a notification from PCBE 134 for every perception state of the individual with was determined and flagged by PCBE 134 as being more difficult for the individual. At step S285, assessment engine 136 may determine which portion, or portions, of the MOOC the individual's difficult perception state(s) corresponds to. Finally, at step S290, assessment engine 136 may dynamically generate an assessment data segment, for transmission to the individual, utilizing questions from pre-designed assessment data segments of the MOOC meant to assess the portions of the MOOC which were determined and flagged, by PCBE 134, as being more difficult for the individual. In doing so, assessment engine 136 may tailor an assessment data segment to assess the individual on the portion(s) of the MOOC where he/she struggled the most, as determined by perception state(s). The dynamically generated assessment data segment may be transmitted to the user out of an order specified for pre-designed assessment data segments of the MOOC.

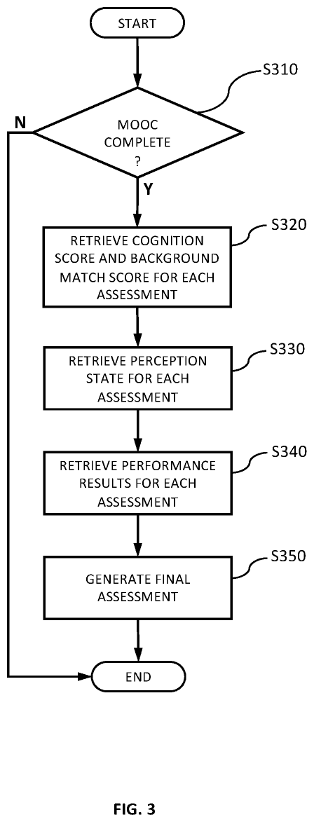

FIG. 3 shows a flowchart illustrating further operations of assessment engine 136 in accordance with an example embodiment of the invention. Referring to step S310, device assessment engine 136 may determine if the MOOC has completed. In making this determination, assessment engine 136 may access data stored in MOOC database 150 which may include digital content of the MOOC and the timing/scheduling of the digital content. Referring to step S320, assessment engine 136 may retrieve the cognition score and the background match score for each assessment data segment taken by the individual, in response to determining that the MOOC has completed (i.e., all lecture presentations have been played and all intermediate assessments have been taken by the individual, via MOOC interface 124). Referring to step S330, assessment engine 136 may retrieve the perception states of the individual for every portion of the MOOC the taken assessment data segments were meant to assess. In steps S320 and S330, assessment engine 136 may access PCBE 134 and/or perception state mapping database 160 to retrieve the necessary data. Referring to step S340, assessment engine 136 may retrieve, from MOOC database 150, performance results of the individual for each assessment data segment of the MOOC taken by the individual. Referring to step S350, assessment engine 136 may generate a final assessment data segment for the MOOC containing questions for the portions of the MOOC where the individual struggled the most as based on the individual's performance (e.g., responses, scores) on earlier assessment data segments of the MOOC, the retrieved perception states of the individual for the portions of the MOOC, the retrieved cognition scores for portions of the MOOC, and the retrieved background match scores for portions of the MOOC.

FIG. 4 depicts a block diagram of components of computing device 120, profiles database 140, MOOC database 150, perception state mapping database 160, and server 130, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computing device 120, profiles database 140, MOOC database 150, perception state mapping database 160, and server 130 include communications fabric 902, which provides communications between computer processor(s) 904, memory 906, persistent storage 908, network adapter 912, and input/output (I/O) interface(s) 914. Communications fabric 902 can be implemented with any architecture designed for passing data and/or control information between processors (such as microprocessors, communications and network processors, etc.), system memory, peripheral devices, and any other hardware components within a system. For example, communications fabric 902 can be implemented with one or more buses.

Memory 906 and persistent storage 908 are computer-readable storage media. In this embodiment, memory 906 includes random access memory (RAM) 916 and cache memory 918. In general, memory 906 can include any suitable volatile or non-volatile computer-readable storage media.

The programs MOOC interface 124 in computing device 120; and assessment retriever 132, perception-cognition-background engine 134, and assessment engine 136 in server 130 are stored in persistent storage 908 for execution by one or more of the respective computer processor(s) 904 via one or more memories of memory 906. In this embodiment, persistent storage 908 includes a magnetic hard disk drive. Alternatively, or in addition to a magnetic hard disk drive, persistent storage 908 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 908 may also be removable. For example, a removable hard drive may be used for persistent storage 908. Other examples include optical and magnetic disks, thumb drives, and smart cards that are inserted into a drive for transfer onto another computer-readable storage medium that is also part of persistent storage 908.

Network adapter 912, in these examples, provides for communications with other data processing systems or devices. In these examples, network adapter 912 includes one or more network interface cards. Network adapter 912 may provide communications through the use of either or both physical and wireless communications links. The programs MOOC interface 124 in computing device 120; and assessment retriever 132, perception-cognition-background engine 134, and assessment engine 136 in server 130 may be downloaded to persistent storage 908 through network adapter 912.

I/O interface(s) 914 allows for input and output of data with other devices that may be connected to computing device 120, profiles database 140, MOOC database 150, perception state mapping database 160, and server 130. For example, I/O interface 914 may provide a connection to external devices 920 such as a keyboard, keypad, a touch screen, and/or some other suitable input device. External devices 920 can also include portable computer-readable storage media such as, for example, thumb drives, portable optical or magnetic disks, and memory cards. Software and data used to practice embodiments of the present invention, e.g., programs MOOC interface 124 in computing device 120; and assessment retriever 132, perception-cognition-background engine 134, and assessment engine 136 in server 130, can be stored on such portable computer-readable storage media and can be loaded onto persistent storage 908 via I/O interface(s) 914. I/O interface(s) 914 can also connect to a display 922.

Display 922 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While steps of the disclosed method and components of the disclosed systems and environments have been sequentially or serially identified using numbers and letters, such numbering or lettering is not an indication that such steps must be performed in the order recited and is merely provided to facilitate clear referencing of the method's steps. Furthermore, steps of the method may be performed in parallel to perform their described functionality.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

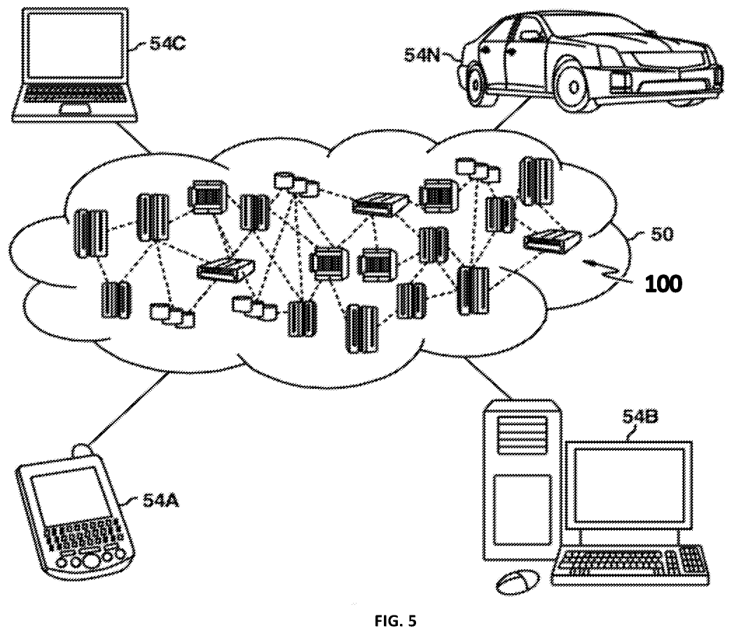

Referring now to FIG. 5, illustrative cloud computing environment 50 is depicted. As shown, cloud computing environment 50 includes one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

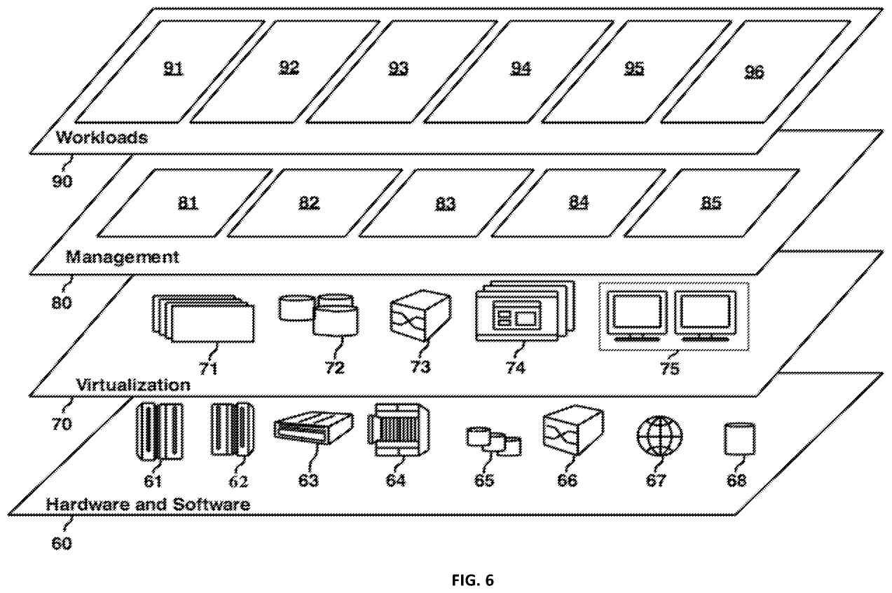

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and personalized assessment system 96. Personalized assessment system 96 may relate to providing personalized assessment data segments to an individual, engaged in a computer-administered course (e.g., a MOOC), based on the known cognitive state of the individual and evolution of the state of perception of the individual while progressing through the course, in addition to profile information of the individual, if available.

The descriptions of the various embodiments of the present invention have been presented for purposes of illustration, but are not intended to be exhaustive or limited to the embodiments disclosed. The terminology used herein was chosen to explain the principles of the one or more embodiments, the practical application or technical improvement over technologies found in the marketplace, or to enable others of ordinary skill in the art to understand the embodiments. Various modifications, additions, substitutions, and the like will be apparent to those of ordinary skill in the art without departing from the scope and spirit of the invention, as defined in the following claims.

What is claimed is:

1. A computer-implemented method for transmission of data segments to a user on a computing device, the method comprising:
controlling a transmission of one or more assessment data segments to the user based on a state of perception of the user determined using sensor data for the user captured by one or more biometric sensors and further based on profile information of the user.

2. The computer-implemented method of claim 1, wherein controlling the transmission comprises:
skipping at least one data segment of the one or more assessment data segments based on the state of perception of the user.

3. The computer-implemented method of claim 1, wherein controlling the transmission comprises:
selecting at least one data segment of the one or more assessment data segments, from a database, for transmission to the user, wherein the selecting is based on the state of perception of the user; and
transmitting the at least one data segment to the user on the computing device.

4. The computer-implemented method of claim 1, wherein controlling the transmission further comprises:
determining an assessment score based on the state of perception of the user, a determined cognition score of the user, and a determined background match score of the user;
comparing the assessment score to a threshold value; and
transmitting at least one assessment data segment of the one or more assessment data segments only in response to the assessment score exceeding the threshold value.

5. The computer-implemented method of claim 1, wherein the one or more biometric sensors comprise a camera of the computing device, and wherein the biometric data comprise one or more facial expressions of the user captured by the camera of the computing device.

6. The computer-implemented method of claim 3, wherein data segments in the database are ordered data segments, and wherein the selecting comprises:
selecting the at least one data segment out of order based on the state of perception of the user.

7. The computer-implemented method of claim 3, wherein the at least one data segment is selected from a group consisting of: an assessment data segment and an educational material data segment.

8. The computer-implemented method of claim 1, wherein controlling a transmission comprises:
receiving an ordered list of one or more assessment data segments for transmission to the user;
transmitting at least one assessment data segment in the one or more assessment data segments to the user;
determining a state of perception of the user using sensor data captured by one or more biometric sensors, wherein the one or more biometric sensors comprise a camera of the computing device;
reordering at least one remaining assessment data segment in the ordered list based on determining the state of perception of the user; and
transmitting the at least one remaining assessment data segment.

9. The computer-implemented method of claim 1, further comprising:
presenting, by an electronic display, the one or more assessment data segments to the user.

10. A computer program product for transmission of data segments to a user on a computing device, the computer program product comprising:
one or more computer-readable tangible storage devices and program instructions stored on at least one of the one or more computer-readable tangible storage devices, wherein the program instructions are executable by a computer, the program instructions comprising:
program instructions to control a transmission of one or more assessment data segments to the user based on a state of perception of the user determined using sensor data for the user captured by one or more biometric sensors and further based on profile information of the user.

11. The computer program product of claim 10, wherein program instructions to control the transmission comprises:
program instructions to skip at least one data segment of the one or more assessment data segments based on the state of perception of the user.

12. The computer program product of claim 10, wherein program instructions to control the transmission comprises:
program instructions to select at least one data segment of the one or more assessment data segments, from a database, for transmission to the user, wherein the selecting is based on the state of perception of the user; and
transmitting the at least one data segment to the user on the computing device.

13. The computer program product of claim 10, wherein program instructions to control the transmission further comprises:
program instructions to determine an assessment score based on the state of perception of the user, a determined cognition score of the user, and a determined background match score of the user;
program instructions to compare the assessment score to a threshold value; and
program instructions to transmit at least one assessment data segment of the one or more assessment data segments only in response to the assessment score exceeding the threshold value.

14. The computer program product of claim 10, wherein the one or more biometric sensors comprise a camera of the computing device, and wherein the biometric data comprise one or more facial expressions of the user captured by the camera of the computing device.

15. The computer program product of claim 12, wherein data segments in the database are ordered data segments, and wherein the program instructions to select comprises:
program instructions to select the at least one data segment out of order based on the state of perception of the user.

16. A computer system for transmission of data segments to a user on a computing device, the computer system comprising:
one or more processors, one or more computer-readable memories, one or more computer-readable tangible storage devices, and program instructions stored on at least one of the one or more computer-readable tangible storage devices for execution by at least one of the one or more processors via at least one of the one or more memories, the program instructions comprising:
program instructions to control a transmission of one or more assessment data segments to the user based on a state of perception of the user determined using sensor data for the user captured by one or more biometric sensors and further based on profile information of the user.

17. The computer system of claim 16, wherein program instructions to control the transmission comprises:
program instructions to skip at least one data segment of the one or more assessment data segments based on the state of perception of the user.

18. The computer system of claim 16, wherein program instructions to control the transmission comprises:
program instructions to select at least one data segment of the one or more assessment data segments, from a database, for transmission to the user, wherein the selecting is based on the state of perception of the user; and
transmitting the at least one data segment to the user on the computing device.

19. The computer system of claim 16, wherein program instructions to control the transmission further comprises:
program instructions to determine an assessment score based on the state of perception of the user, a determined cognition score of the user, and a determined background match score of the user;
program instructions to compare the assessment score to a threshold value; and
program instructions to transmit at least one assessment data segment of the one or more assessment data segments only in response to the assessment score exceeding the threshold value.

20. The computer system of claim 16, wherein the one or more biometric sensors comprise a camera of the computing device, and wherein the biometric data comprise one or more facial expressions of the user captured by the camera of the computing device.
